(19) United States
(12) Patent Application Publication
(10) Pub. No.: US 2013/0140753 A1
(43) Pub. Date: Jun. 6, 2013

(54) KITCHEN APPLIANCE AND PROCESSING CONTAINER HAVING A COUPLING DEVICE

(71) Applicants: Andrej Blagotinsek, Slovenj Gradec (SI); Ales Brecko, Celje (SI); Matej Cater, Petrovce (SI); Uros Jegrisnik, Polzela (SI); Peter Kovacic, Gomilsko (SI)

(72) Inventors: Andrej Blagotinsek, Slovenj Gradec (SI); Ales Brecko, Celje (SI); Matej Cater, Petrovce (SI); Uros Jegrisnik, Polzela (SI); Peter Kovacic, Gomilsko (SI)

(73) Assignee: BSH BOSCH UND SIEMENS HAUSGERÄTE GMBH, Munich (DE)

(21) Appl. No.: 13/816,504

(22) PCT Filed: Aug. 11, 2011
(86) PCT No.: PCT/EP2011/063850

§ 371 Date: Feb. 12, 2013

(30) Foreign Application Priority Data
Aug. 24, 2010 (DE) 10 2010 039 718.0

(51) Int. Cl. A47J 43/07; F16B 1/00; F16B 5/00

(52) U.S. Cl. CPC A47J 43/07; F16B 5/008; F16B 1/0071
USPC 269/309; 269/289 R; 403/349; 403/27

(57) ABSTRACT

A kitchen appliance includes a coupling plate having an edge enclosing an inner area and provided with coupling points of a coupling device for removable coupling of a processing container. The coupling plate is configured in the inner area in either of two ways, a first way in which the coupling plate has a pin which projects in a coupling direction for engagement in a groove in a base section of the processing container, a second way in which the coupling plate has a groove for engagement of a pin which projects in the coupling direction from the base section of the processing container.

### FIELD OF THE INVENTION

The invention relates to a kitchen appliance having a coupling plate for a processing container, wherein the coupling plate comprises coupling points of a coupling device at the edge thereof for removably coupling the processing container. The invention further relates to a processing container for a kitchen appliance, wherein a base of the processing container comprises mating coupling points of a mating coupling device at the edge thereof for removably attaching to a coupling plate of the kitchen appliance. Finally the invention relates to a system comprising the kitchen appliance and the processing container.

### BACKGROUND OF THE INVENTION

Kitchen machines are known from the prior art, such as the MUM range from Bosch and Siemens Hausgeräte GmbH for example, which have a base with a coupling plate to which a mixing bowl can be coupled. These machines also have an electric motor which drives a rotating tool, e.g. a kneading tool or a mixing tool which, when the processing container is coupled on, projects into said container in order to process foodstuffs held in the container.

International patent application WO 2007/023117 A1 further discloses a kitchen appliance equipped with a coupling point for a mixing bowl which is equipped with a reed switch at the coupling point which interacts with the magnet in the base of the mixing bowl and controls the supply of current to the drive motor of the kitchen appliance such that the motor can only be put into operation when the mixing bowl is correctly coupled to the coupling point. A similar device is known from European patent EP 1 921 957 B1.

The German publication DE 31 21 252 A1 also discloses a multi-purpose household appliance with a number of exchangeable food-processing tools and a removable bowl. The household appliance includes a magnetically-acting safety lock with which an inventive positioning of the bowl in the household appliance is monitored. Malfunctions of the magnetic safety lock are avoided through the use of alternating magnetic fluxes.

Finally European patent application EP 1 880 647 A1 discloses a stand mixer, the base of which is equipped to accommodate a mixing bowl with weight sensors in order to determine the weight of the ingredients present in the bowl.

### UNDERLYING OBJECT OF THE INVENTION

The underlying object of the invention is to provide an improved kitchen appliance with a coupling plate for a processing container, in which the coupling plate has at its edge coupling points of a coupling device, for removable coupling of the processing container. An improved processing container for a kitchen appliance is also to be provided in which a base of the processing container has mating coupling points of a mating coupling device at its edge for removable attachment to a coupling plate of the kitchen appliance. The improved kitchen appliance and the improved processing container are intended in particular to prevent an incorrectly oriented coupling of the processing container on the kitchen appliance. The object is designed to be realized simply and at low cost and make simple handling possible for the user.

### INVENTIVE SOLUTION

To achieve the object the present invention discloses a kitchen appliance with a coupling plate for a processing container, wherein the coupling plate has coupling points of a coupling device at its edge for removable coupling of the processing container. In its inner area enclosed by its edge the coupling plate has either a projecting pin which can engage in a groove in the base of the processing container or a groove into which the pin projecting from the base of the processing container in the coupling direction can engage.

The object is further achieved by a processing container for a kitchen appliance in which a base section of the processing container has mating coupling points of a mating coupling device at its edge for removable attachment to a coupling plate of the kitchen appliance. The base section, in its inner area enclosed by its edge, has either a pin projecting in the coupling direction which can engage in a groove in the coupling plate of the kitchen appliance or a slot into which a pin projecting from the coupling plate of the kitchen appliance in the coupling direction can engage. Finally the object is achieved by a system consisting of the kitchen appliance and the processing container.

The coupling device of the kitchen appliance and the mating coupling device of the processing container can interact as a type of bayonet connection. At each coupling point, either the coupling or the mating coupling has a coupling stud for this purpose pointing radially away from a coupling axis. In the coupled state the coupling studs engage behind a latching edge of the mating coupling point or coupling point corresponding to the coupling point or the mating coupling point. In such cases the connection can be made by a push-and-turn movement: Initially the container is inserted into the coupling plate in the coupling direction along the coupling axis, wherein the pin is guided past the latching edge in the coupling direction. By a subsequent rotational movement around the coupling axis the pin arrives under the latching edge.

The coupling device or mating coupling device can however for example also have threaded sections as coupling points and mating coupling points. In this case the connection can be made by a screw movement, wherein the threaded sections of the coupling point of the kitchen appliance and the threaded sections of the mating coupling points of the processing container engage into each other by means of a thread in the coupled state.

The result of inventive pin or the inventive groove is that the processing container can only be coupled to the coupling plate in a specific orientation, namely in the orientation in which the pin engages into the groove. “Orientation” here means an angular position around the coupling axis. The invention is of particular advantage where the coupling device, as a result of its symmetry alone, would allow a number of orientations to the processing container for coupling. For example with a symmetrically embodied bayonet coupling with three coupling points, three orientations offset at 120° in each case in relation to the coupling axis are possible. By the inventive pin in interaction with the inventive groove one of these orientations can be defined as the only orientation in which coupling is possible.

The fact that the processing container can only be coupled in a specific orientation means that it is then desirable for an actuation element to be disposed on the processing container at one point which interacts with a detection means in the kitchen appliance in order to detect a coupled processing container. In such cases the situation in which the actuation means or the detection means has to be provided a number of times can be advantageously avoided by the invention.

The invention is especially suitable for kitchen appliances with an electric motor especially electric motor-driven kitchen machines, e.g. universal kitchen machines. The processing container is for example a bowl or a mixing bowl.

### STRUCTURE AND DEVELOPMENT OF THE INVENTIVE SOLUTION

Advantageous embodiments and developments, which can be used individually or in combination with one another, are the subject matter of the dependent claims.

In a preferred embodiment of the invention the coupling plate, in its inner area enclosed by its edge, has a pin projecting in the coupling direction. The pin can engage in a slot in the base of the processing container. In this case the pin is disposed eccentrically. “Eccentrically” here means outside the center of the coupling plate. The center of the coupling plate lies where the imaginary coupling axis penetrates the coupling plate. Especially preferably the pin or the groove is disposed in a central third of a radius from the center of the coupling plate to the crown gear. The advantageous result achieved by this embodiment of the invention is that the position of the pin in relation to the coupling axis is not symmetrical and thereby characterizes a specific orientation with regard to the other orientations. Preferably the pin is disposed in the coupling direction essentially at the height of the kitchen appliance-side connection point of the coupling device.

Accordingly this pin is also arranged eccentrically if the base of the processing container, in its inner area enclosed by its edge, has a pin projecting in the coupling direction which can engage in a groove in the coupling plate of the kitchen appliance, meaning that it is outside the center of the base. The center of the base lies where the imaginary coupling axis passes through the base. With a processing container made of steel the pin can be embossed into the base.

In an embodiment of the invention the coupling plate is equipped with a groove in its inner area enclosed by its edge, into which a pin projecting from the base of the processing container in the coupling direction can engage, wherein the groove extends along a section of an imaginary circle with the center of the coupling plate as the center point of circle. The groove is preferably designed with respect to its length and position in the coupling plate so that the pin, on insertion of the processing container, engages in the groove and on rotation of the processing container around the coupling axis for the purposes of coupling, runs in the groove. Preferably the pin is located at one end of the groove on insertion and at the other end of the groove when the container is coupled. In other words the length of the groove is chosen precisely so that the pin moves in the groove from one end to the other end during the coupling process. Preferably the groove is located in a central third of a radius from the center of the coupling plate to the edge of the coupling plate.

In a preferred embodiment of the invention the base section, in its inner area enclosed by its edge, has a groove into which a pin projecting from the coupling plate of the kitchen appliance in the coupling direction can engage, wherein the groove extends along a section of an imaginary circle with the center of the base section as the center point of the circle. In respect of its length and position the groove is disposed in the base section so that the pin, on insertion of the processing container, engages in the groove and on rotation of the processing container around the coupling axis for the purpose of coupling, runs in the groove. Preferably the pin is located on insertion at one end of the groove and, with the container coupled, is located at the other end of the groove. In other words the length of the groove is selected so that the pin runs in the groove from one end to the under end during the coupling process. Preferably the groove is located in a central third of the radius from the center of the base to the edge of the base. With a processing container made of steel the groove can be embossed into the base part.

In a preferred embodiment of the invention the coupling points of the coupling device are disposed rotationally symmetrical around the coupling axis. Accordingly the mating coupling points of the mating coupling device are also preferably disposed rotationally symmetrically around the coupling axis. The coupling points or mating coupling points respectively can for example involve coupling points of a bayonet connection, i.e. coupling studs or latching edges for example. However threaded sections can also be involved for example which engage as a threaded connection with one another when the processing container is coupled. Advantageously a symmetrical arrangement of the coupling points or mating coupling points respectively can ensure a particularly secure fit of the processing container in the coupling plate. Preferably the coupling device or the mating coupling device respectively each comprise at least three coupling points.

A preferred kitchen appliance is equipped with a latching means, in order to define the processing container coupled to the kitchen appliance in its coupled position. The processing container is accordingly preferably equipped with mating latching means. The latching means can for example be a spring-loaded latching peg. Preferably the latching means is disposed and embodied such that it interacts with a mating coupling point of the mating coupling device of the processing container as a mating latching means. For example a coupling stud of a mating bayonet coupling can act on a threaded section of a threaded mating coupling as a mating latching means. Preferably latching means and mating latching means are embodied so that a latching force which is to be overcome during coupling of the processing container for latching essentially corresponds to an unlatching force which is to be overcome for unlatching on decoupling the processing container.

Furthermore a preferred kitchen appliance has a detector in order to detect whether the processing container is coupled to the kitchen appliance, preferably to detect whether the processing container is coupled to the kitchen appliance in an intended orientation. An especially preferred detector is an electrical switch which is actuated when the processing container is coupled correctly. Preferably the switch interacts for actuation with a mating coupling point of the coupling device, e.g. a coupling stud of a mating bayonet coupling or a threaded section of a mating threaded coupling of the processing container.

A suitable switch can for example be a magnetic switch. For this purpose a permanent magnet which acts on the magnetic switch is preferably disposed on the processing container at a point where, with a correctly coupled processing container, it lies opposite the magnetic switch. The magnetic switch is a mechanical switch for example of which the actuation element is embodied from metal or has a metal part. This can be actuated by the permanent magnet of the processing container when the processing container is in a correctly coupled position and thereby change the switching state of the switch, preferably switch it on. As an alternative the switch can for example be embodied as a reed switch. Such a switch can be actuated with a permanent magnet of the processing container. Both the magnetic switch and also the permanent magnet are preferably completely surrounded by an enclosure in the housing of the kitchen appliance or the processing container. This enables them to be protected from contamination and damage.

### BRIEF DESCRIPTION OF THE DRAWINGS

Further advantageous embodiments are described in greater detail below with reference to the exemplary embodiments presented in the drawings, to which the invention is not restricted however.

The schematic diagrams shown in the drawings are as follows:

FIG. 1 shows an inventive kitchen appliance in a perspective oblique view from above;

FIG. 2 shows the coupling plate of an inventive kitchen appliance and a processing container in a perspective oblique view from above and to the side;

FIG. 3 shows an inventive processing container in a perspective oblique view, from above and to the side, looking a the base section;

FIG. 4 shows a section of the processing container from FIG. 3 with a direct view from below onto the base section of the processing container;

FIG. 5 shows a cross-sectional view through the plane of the coupling device of the coupling plate of FIG. 2; and

FIG. 6 shows an inventive kitchen appliance and an inventive processing container in a perspective exploded view, from above and to the side, with a magnetic switch as detector in the kitchen appliance and a permanent magnet in the processing container for actuating the magnetic switch.

### DETAILED DESCRIPTION REFERRING TO EXEMPLARY EMBODIMENTS

In the description given below of preferred embodiments of the present invention the same reference characters refer to the same or comparable components.

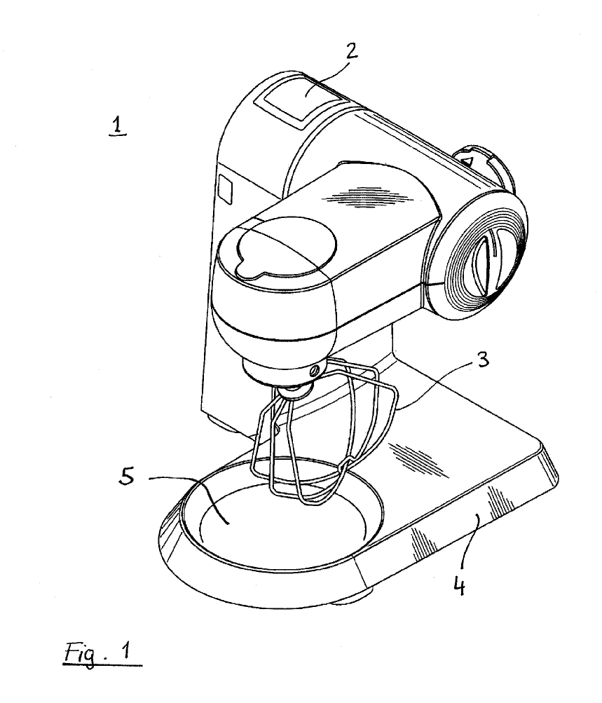

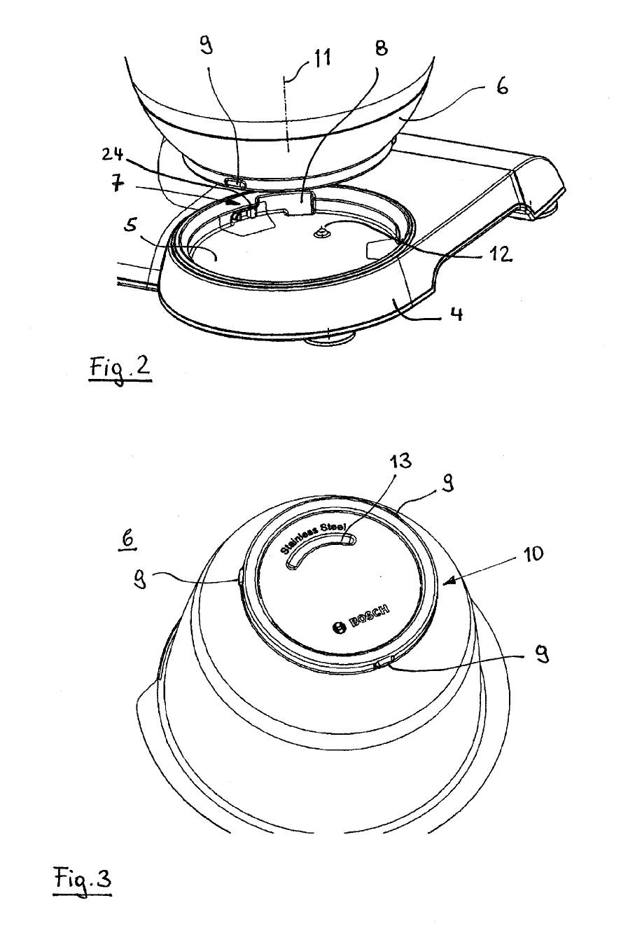

FIG. 1 shows a kitchen machine 1 as a kitchen appliance with a housing enclosing an electric motor (not shown) which can be switched on and off with an ON/OFF switch 2 on the housing. The electric motor can impart rotation to an exchangeable processing device. In the figure a whisk 3 is shown as a processing device for example. The base 4 of the kitchen machine 1 is equipped with a coupling plate 5 to which a processing container, e.g. the mixing bowl 6 depicted in FIGS. 2 and 3, can be coupled rigidly, but so that it can be removed again. The mixing bowl 6 can then be filled with ingredients, e.g. a cake mix, which can then be processed by the processing tool 3.

The coupling plate 5 is shown in greater detail in FIG. 2. It has a bayonet coupling facility with three coupling points 7, of which one is visible in the figure. The coupling points 7 have a broad vertical groove 8, into which a corresponding coupling stud 9 of a base section 10 of the mixing bowl 6 can be introduced from above, i.e. in the coupling direction along the coupling axis 11, if the mixing bowl 6 is placed on the coupling plate 5. Subsequently the coupling studs 9 can be guided by rotation of the mixing bowl 6 in a counterclockwise direction around the coupling axis 11 below a latching edge 24 of the respective coupling point 7.

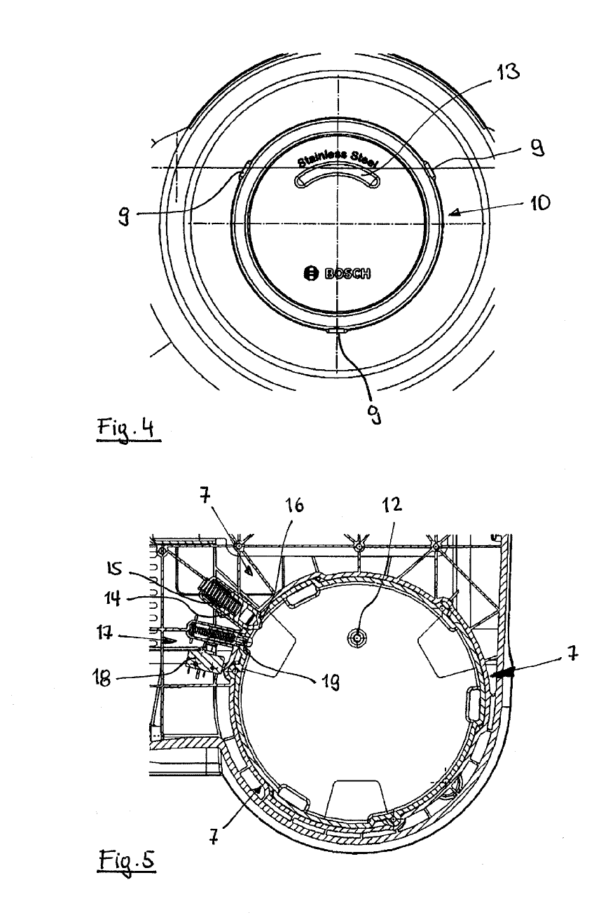

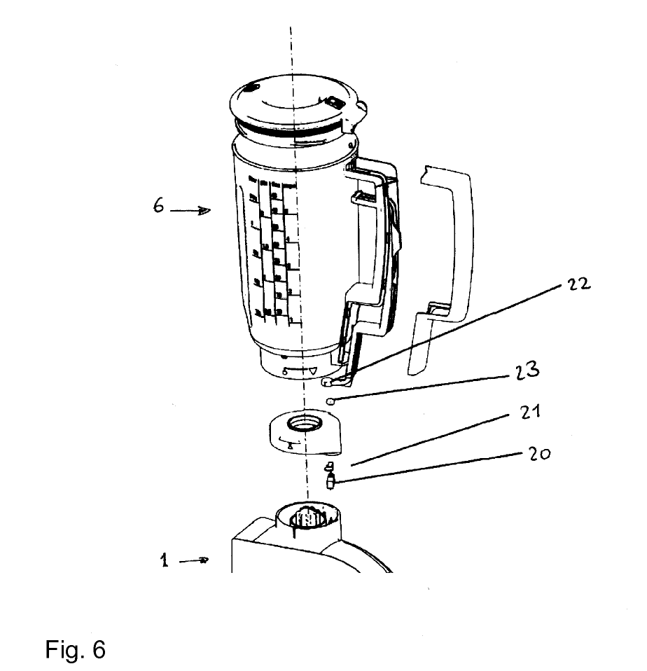

In FIG. 3 the mixing bowl 6 is shown in a perspective oblique view onto the base section 10 and in FIG. 4 is shown looking from above down onto the base section 10. In the two figures the three coupling studs 9 of the mixing bowl 6, which interact as mating coupling points with the coupling points of the kitchen machine 1 to form a bayonet connection, can readily be seen. Both the coupling points 7 of the kitchen machine and also the corresponding mating coupling points of the mixing bowl 6 are disposed rotationally symmetrically at the edge of the coupling plate 5 or of the base section 10 respectively and are spaced from one another by 120° in each case.

As can best be seen in FIG. 2, the coupling plate 5 has a projecting pin 12 in its inner area enclosed by the edge of the coupling plate 5, which can engage into the corresponding groove 13 of the base section 10 of the mixing bowl 6 shown in FIGS. 3 and 4 when the mixing bowl 6 is placed in the correct orientation, i.e. in the desired angle of rotation in relation to the coupling axis 11, on the coupling plate 5. The pin 12 is located in the area of the central third of a radius from the center of the coupling plate 5, i.e. from the point at which the imaginary coupling axis 11 passes through the coupling plate 5, and the edge of the coupling plate 10.

Accordingly the groove 13 of the base section 10 is also located in the central third of its radius from the center of the base section 10 to its edge, wherein the center of the base section 10 is once again the point at which the coupling axis passes through the base section 10. The groove 13 has the shape of the segment of a circle, of which the center point is formed by the center of the base section 10. The groove 13 is positioned and embodied so that, when the mixing bowl is inserted, the pin engages into the groove 13 at a first end and on subsequent rotation of the mixing bowl around the coupling axis 11, in which the coupling stud 9 is guided under the latching edge 12, said pin runs along the groove 13, until it comes to rest in the latched position of the mixing bowl 6 at the other end of the groove 13.

As is especially easy to see in FIG. 5, the kitchen machine 1 is equipped in the area of one of the coupling points 7 with a rod-type spring-loaded locking rod 14, which is pre-tensioned with a coil spring 15 in the direction of the center of the coupling plate 5 and interacts with a coupling stud 9 of the mixing bowl 6. To this end the rod 14 has a spherical shape at its tip 16 in order to present an introduction taper. When the coupling stud 9 of the mixing bowl 6 assigned to the coupling point 7, by counterclockwise rotation of the mixing bowl 6 around the coupling axis 11, passes the rod 14 in its end position, said rod is displaced against the spring force and moves after the coupling stud 9 has been guided past the rod 14, back again in the direction of the center of the coupling plate 7. This locks the mixing bowl 6 in its coupled position. The same occurs when the mixing bowl 6, by turning the mixing bowl 6 in the opposite direction, i.e. clockwise around the coupling axis 11, is released again from the coupling plate 5 from its locked position. In any event the coupling stud 9 must overcome a certain force to get past the rod 14 because of the tension of the spring 15.

In addition one of the coupling points 7 of the kitchen machine 1 is also equipped with a detector 17 which has an electrical switch 18 with a sensor peg 19 likewise pre-tensioned with a spring 20 in the direction of the center of the coupling plate 5. In the coupled position the coupling stud 9 of the mixing bowl 6 actuates the sensor peg 19 of the detector 17 such that the electrical switch 18 switches into a state from non-conducting to conducting. The kitchen machine 1 is equipped with a controller (not shown) which, even with the ON/OFF switch 2 switched on, only allows an actuation of the electric motor in this case. This enables it to be ensured that the kitchen machine 1 cannot be put into operation with a mixing bowl 6 not inserted or incorrectly inserted.

Finally FIG. 5 shows a mixer 1 as an alternative embodiment of the kitchen appliance as well as a mixing bowl 9 as processing container. Here the detector 17 is embodied as a magnetic switch, more precisely as a magnetically-actuatable electrical micro switch 20. The micro switch 20 has a ferrous metal lever 21 which can be actuated by a magnetic field. The mixing bowl 9 is equipped at one point 22 with a permanent magnet 23 which, on correct positioning of the mixing bowl 6, lies opposite the lever 21 of the micro switch 20 and therefore actuates said lever with its magnetic force. Both the detector and also the permanent magnet 23 are disposed within the housing of the mixer 1 or of the mixing bowl 6 in order to protect these parts from contamination and damage.

The improved kitchen appliance and the improved processing device can prevent an incorrectly oriented coupling of the processing container to the kitchen appliance. The solution can be realized in a simple manner and at low cost and facilitates handling for the user.

The features disclosed in the present description, the claims and the drawings can be of significance both individually and also in any given combination for the implementation of the invention with its different embodiments. The reference characters in the claims are only intended to improve their readability and should not be understood as a restriction to a specific embodiment.

### LIST OF REFERENCE CHARACTERS

1 Kitchen machine, Mixer
2 ON/OFF switch
3 Processing tool
4 Base
5 Coupling plate
6 Bowl, mixing bowl
7 Coupling point
8 Vertical groove
9 Coupling stud
10 Base section
11 Coupling axis
12 Pin
13 Groove
14 Locking rod
15 Spring
16 Tip of locking rod
17 Detector
18 Switch
19 Sensor peg
20 Switch
21 Lever
22 Location of the permanent magnet on the mixing bowl
23 Permanent magnet
24 Latching edge

1-14. (canceled)

15. A kitchen appliance, comprising a coupling plate having an edge enclosing an inner area and provided with coupling points of a coupling device for removable coupling of a processing container, said coupling plate being configured in the inner area in either of two ways, a first way in which the coupling plate has a pin which projects in a coupling direction for engagement in a groove in a base section of the processing container, a second way in which the coupling plate has a groove for engagement of a pin which projects in the coupling direction from the base section of the processing container.

16. The kitchen appliance of claim 15, wherein the pin of the coupling plate is disposed eccentrically, when the coupling plate is configured in the first way.

17. The kitchen appliance of claim 15, wherein the groove of the coupling plate extends along a section of an imaginary circle with a center of the coupling plate as a center point of the circle, when the coupling plate is configured in the second way.

18. The kitchen appliance of claim 15, wherein the coupling points of the coupling device are disposed rotationally symmetrically around a coupling axis.

19. The kitchen appliance of claim 15, further comprising a latch securing the processing container in a coupled position.

20. The kitchen appliance of claim 19, wherein the latch is configured to interact with a mating coupling point of a bayonet mating connection of the processing container as mating latching point.

21. The kitchen appliance of claim 15, further comprising a detector configured to detect whether the processing container is coupled to the kitchen appliance.

22. The kitchen appliance of claim 21, wherein the detector is an electrical switch.

23. The kitchen appliance of claim 22, wherein the electrical switch is configured for magnetic actuation.

24. A processing container for a kitchen appliance, comprising a base section having an edge enclosing an inner area and provided with mating coupling points of a mating coupling device for removable attachment to a coupling plate of the kitchen appliance, said base section being configured in the inner area in either of two ways, a first way in which the base section has a pin which projects in a coupling direction for engagement in a groove in the coupling plate of the kitchen appliance, a second way in which the base section has a groove for engagement of a pin which projects in the coupling direction from the coupling plate of the kitchen appliance.

25. The processing container of claim 24, wherein the groove of the base section extends along a section of an imaginary circle, with a center of the base section as a center point of the circle, when the base section is configured in the second way.

26. The processing container of claim 24, wherein the pin of the base section is disposed eccentrically, when the base section is configured in the first way.

27. The processing container of claim 24, wherein the coupling device is a bayonet coupling, with the mating coupling points of the bayonet coupling being disposed rotationally symmetrically around a coupling axis.

28. A system, comprising:
a kitchen appliance including a coupling plate having an edge enclosing an inner area and provided with first coupling points of a coupling device; and
a processing container including a base section having an edge enclosing an inner area and provided with second coupling points of the coupling device for engagement with the first coupling points to allow removable coupling of the processing container to the kitchen appliance,
wherein one member selected from the group consisting of the coupling plate of the kitchen appliance and the base section of the processing center has as one of the first and second coupling points in the inner area of the member a pin which projects in a coupling direction for engagement in a groove defining the other one of the first and second coupling points and provided in the other member of the group.

29. The system of claim 28, wherein the pin is disposed eccentrically.

30. The system of claim 28, wherein the groove extends along a section of an imaginary circle with a center of the member as a center point of the circle.

31. The system of claim 28, wherein the first and second coupling points are disposed rotationally symmetrically around a coupling axis.

32. The system of claim 28, further comprising a latch securing the processing container in a coupled position.

33. The system of claim 32, wherein the latch is configured to interact with a mating coupling point of a bayonet mating connection of the processing container as mating latching point.

34. The system of claim 28, further comprising a detector configured to detect whether the processing container is coupled to the kitchen appliance.

35. The system of claim 34, wherein the detector is an electrical switch.

36. The system of claim 35, wherein the electrical switch is configured for magnetic actuation.
